(19) United States
(12) Patent Application Publication
(10) Pub. No.: US 2023/0127653 A1
(43) Pub. Date: Apr. 27, 2023

(54) SWITCHING SYSTEM OF EDR WATER PURIFIER WITH FOUR WAY SOLENOID VALVE

(71) Applicants: Ching-Hsiung LIN, Pingtung City (TW); Kemflo (Nanjing) Environmental Technology Co., Ltd., Nanjing (CN); KEMFLO INTERNATIONAL CO., LTD., Pingtung City (TW)

(72) Inventors: Allen DING, Nanjing (CN); Edison FAN, Nanjing (CN)

(21) Appl. No.: 17/543,277

(22) Filed: Dec. 6, 2021

(30) Foreign Application Priority Data
Oct. 26, 2021 (CN) 202111249053.3

(51) Int. Cl. B01D 61/52; B01D 61/46; B01D 61/54; C02F 1/469; G05D 7/06

(52) U.S. Cl. CPC B01D 61/52; B01D 61/46; B01D 61/54; C02F 1/4695; G05D 7/0652; C02F 2201/005; B01D 2313/18

(57) ABSTRACT

A switching system for an EDR water purifier has a first raw-water inlet end, a second raw-water inlet end, two four-way solenoid valves, an EDR membrane stack, a freshwater outlet end, and a wastewater outlet end. Each four-way solenoid valve has a first inlet end, a second inlet end, a first outlet end, and a second outlet end. The first inlet end of each four-way solenoid valve can communicate with one of the first outlet end and the second outlet end of the same four-way solenoid valve, and the second inlet end of the same four-way solenoid valve can communicate with the other one of the first outlet end and the second outlet end, to execute water-route switching. By switching two water routes passing through the EDR membrane stack, forming of limescale is alleviated, lifespan of the EDR membrane stack is extended, and water-purifying efficiency is improved.

### BACKGROUND OF THE INVENTION

### 1. Field of the Invention

The present invention relates to a switching system of a water purifier, and more particularly to a switching system of an electrodialysis reversal (EDR) water purifier.

### 2. Description of Related Art

With continuous improvement of life quality, most families have water purifiers in their houses to assure healthy drinking water. However, one-way operation of an EDR membrane stack of a conventional EDR water purifier in the long run leads to accumulation of ions in a concentrated water tank and precipitated limescale. As a result, functions of the EDR membrane stack of the conventional EDR water purifier tend to decay dramatically, lifespan of the EDR membrane stack is shortened, and efficiency of the conventional EDR water purifier decreases.

To solve this problem, workers used to wash the EDR membrane stack along with a cathode and an anode thereof to reduce total dissolved solids (TDS) in the EDR membrane stack, while this way not only causes waste of water, but is also time-consuming and labor-consuming.

In view of this, an improved solution to the aforementioned problem is desired by the industry.

### SUMMARY OF THE INVENTION

The main objective of the present invention is to provide a switching system of an EDR water purifier, wherein two sides of an EDR membrane stack of the EDR water purifier are respectively connected to a four-way solenoid valve. By switching two water routes that pass through the EDR membrane stack via the two four-way solenoid valves, and by exchanging polarity of two electrodes of the EDR membrane stack, forming of limescale is effectively alleviated, lifespan of the EDR membrane stack is extended, and water-purifying efficiency is improved.

For achieving the above-mentioned purpose, the switching system of the EDR water purifier has a first raw-water inlet end, a second raw-water inlet end, a first four-way solenoid valve, a second four-way solenoid valve, an electrodialysis reversal (EDR) membrane stack, a freshwater outlet end, and a wastewater outlet end. Each one of the first four-way solenoid valve and the second four-way solenoid valve has a first inlet end, a second inlet end, a first outlet end, and a second outlet end. The EDR membrane stack has a first inlet port, a second inlet port, a first outlet port, a second outlet port, a first electrode, and a second electrode.

The first raw-water inlet end communicates with the first inlet end of the first four-way solenoid valve, and the second raw-water inlet end communicates with the second inlet end of the first four-way solenoid valve. The first inlet end of the first four-way solenoid valve is configured to communicate with one of the first outlet end and the second outlet end of the first four-way solenoid valve, and the second inlet end of the first four-way solenoid valve is configured to communicate with the other one of the first outlet end and the second outlet end of the first four-way solenoid valve, so two water routes passing through the first four-way solenoid valve are switchable. The first inlet end of the second four-way solenoid valve is configured to communicate with one of the first outlet end and the second outlet end of the second four-way solenoid valve, and the second inlet end of the second four-way solenoid valve is configured to communicate with the other one of the first outlet end and the second outlet end of the second four-way solenoid valve, so two water routes passing through the second four-way solenoid valve are switchable.

The first outlet end of the first four-way solenoid valve communicates with the first inlet port of the EDR membrane stack, and the second outlet end of the first four-way solenoid valve communicates with the second inlet port of the EDR membrane stack. The first outlet port of the EDR membrane stack communicates with the first inlet end of the second four-way solenoid valve, and the second outlet port of the EDR membrane stack communicates with the second inlet end of the second four-way solenoid valve. The freshwater outlet end communicates with the first outlet end of the second four-way solenoid valve, and the wastewater outlet end communicates with the second outlet of the second four-way solenoid valve.

Furthermore, the switching system comprises an electronic control device configured to control exchanging of polarity of the first electrode and the second electrode of the EDR membrane stack, and to control switching of the water routes passing through the first four-way solenoid valve and the second four-way solenoid valve.

A working principle of the present invention is: because the two four-way solenoid valves are connected to the two sides of the EDR membrane stack, switching two water routes that pass through the EDR membrane stack via the two four-way solenoid valves and exchanging the polarity of two electrodes of the EDR membrane stack by reversing electric currents applied on the two electrodes may be achieved.

The switching system of the EDR water purifier can effectively alleviate forming of limescale, extend the lifespan of the EDR membrane stack, and improve water-purifying efficiency.

### BRIEF DESCRIPTION OF THE DRAWINGS

FIG. 1 is a hydraulic schematic diagram of a switching system of an EDR water purifier in accordance with the present invention;

FIG. 2 is an operational hydraulic schematic diagram of the switching system of the EDR water purifier in FIG. 1, showing a communication state; and

FIG. 3 is another operational hydraulic schematic diagram of the switching system of the EDR water purifier in FIG. 1, showing a switched state.

### DETAILED DESCRIPTION OF THE PREFERRED EMBODIMENT

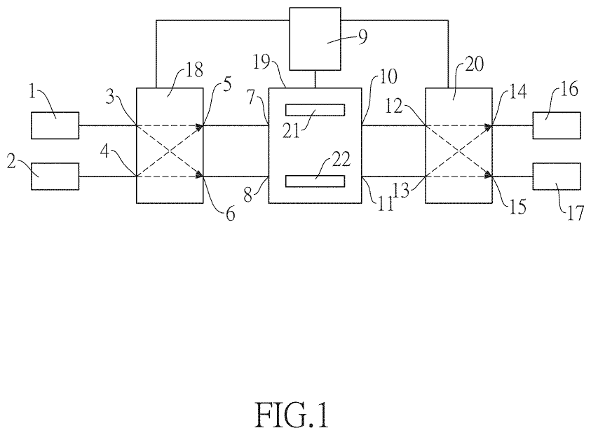

With reference to FIG. 1, a switching system of an electrodialysis reversal (EDR) water purifier in accordance with the present invention has a first raw-water inlet end 1, a second raw-water inlet end 2, a first four-way solenoid valve 18, a second four-way solenoid valve 20, an EDR membrane stack 19, a freshwater outlet end 16, and a wastewater outlet end 17. Each one of the two four-way solenoid valves (i.e. the first four-way solenoid valve 18 and the second four-way solenoid valve 20) has a first inlet end 3, 12, a second inlet end 4, 13, a first outlet end 5, 14, and a second outlet end 6, 15. The EDR membrane stack 19 has a first inlet port 7, a second inlet port 8, a first outlet port 10, a second outlet port 11, a first electrode 21, and a second electrode 22.

The first raw-water inlet end 1 communicates with the first inlet end 3 of the first four-way solenoid valve 18, and the second raw-water inlet end 2 communicates with the second inlet end 4 of the first four-way solenoid valve 18. The first inlet end 3, 12 of each one of the two four-way solenoid valves 18, 20 is capable of being switched to communicate with either one of the first outlet end 5, 14 and the second outlet end 6, 15 of the same four-way solenoid valve 18, 20, and the second inlet end 4, 13 of the same four-way solenoid valve 18, 20 is capable of being switched to communicate with the other one of the first outlet end 5, 14 and the second outlet end 6, 15, to execute water-route switching.

The first outlet end 5 of the first four-way solenoid valve 18 communicates with the first inlet port 7 of the EDR membrane stack 19, and the second outlet end 6 of the first four-way solenoid valve 18 communicates with the second inlet port 8 of the EDR membrane stack 19. The first outlet port 10 of the EDR membrane stack 19 communicates with the first inlet end 12 of the second four-way solenoid valve 20, and the second outlet port 11 of the EDR membrane stack 19 communicates with the second inlet end 13 of the second four-way solenoid valve 20. The freshwater outlet end 16 communicates with the first outlet end 14 of the second four-way solenoid valve 20, and the wastewater outlet end 17 communicates with the second outlet 15 of the second four-way solenoid valve 20.

Furthermore, the switching system comprises an electronic control device 9. The electronic control device 9 is electrically connected to the EDR membrane stack 19, the first four-way solenoid valve 18, and the second four-way solenoid valve 20, so as to control exchanging of polarity of the first electrode 21 and the second electrode 22 of the EDR membrane stack 19 and to control water-route switching.

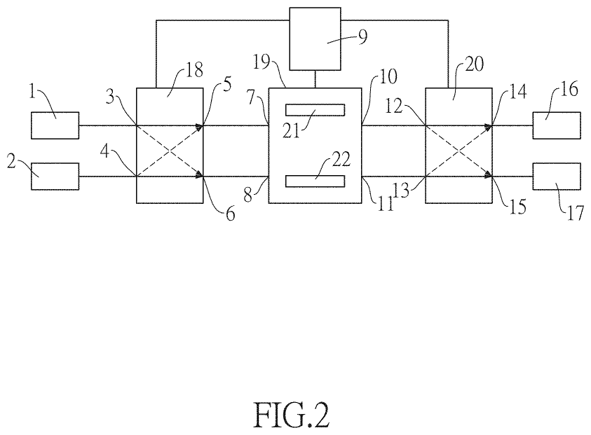

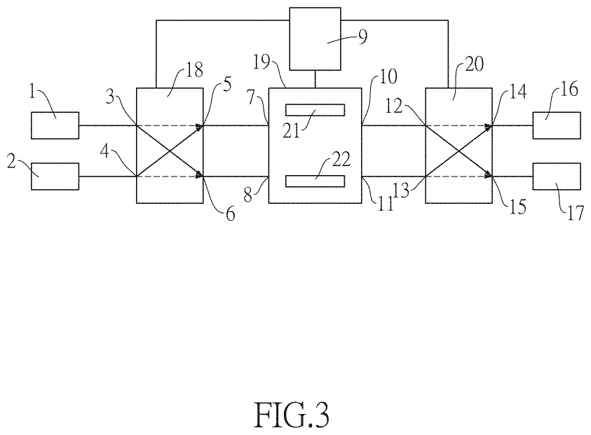

For example, with reference to FIG. 2, in the communication state, the first inlet end 3 of the first four-way solenoid valve 18 communicates with the first outlet end 5, and the second inlet end 4 communicates with the second outlet end 6. The first inlet end 12 of the second four-way solenoid valve 20 communicates with the first outlet end 14, and the second inlet end 13 communicates with the second outlet end 15. With reference to FIG. 3, in a switched state, the first inlet end 3 of the first four-way solenoid valve 18 communicates with the second outlet end 6, and the second inlet end 4 communicates with the first outlet end 5. The first inlet end 12 of the second four-way solenoid valve 20 communicates with the second outlet end 15, and the second inlet end 13 communicates with the first outlet end 14.

For example, in the communication state, the first electrode 21 is positively charged, and the second electrode 22 is negatively charged. In the switched state, the first electrode 21 is negatively charged, and the second electrode 22 is positively charged.

A working principle of the switching system of the EDR water purifier is: because the two four-way solenoid valves 18, 20 are connected to the two sides of the EDR membrane stack 19, switching two water routes that pass through the EDR membrane stack 19 via the two four-way solenoid valves 18, 20 and exchanging the polarity of two electrodes 21, 22 of the EDR membrane stack 19 by reversing electric currents applied on the two electrodes 21, 22 may be achieved. Therefore, forming of limescale can be effectively alleviated, lifespan of the EDR membrane stack 19 can be extended, and water-purifying efficiency can be improved.

The foregoing paragraphs merely show the embodiment of the present invention. Although the description elaborates the embodiment, it shall not constitute restrictions on claims of the present invention. Without departing from the technical means of the present invention, a person having ordinary skill in the art may make some changes and improvements thereto, and those changes and improvements fall within the protection scope of the present invention. Thus the protection scope of the present invention depends on the claims of the present invention.

What is claimed is:

1. A switching system of an electrodialysis reversal (EDR) water purifier comprising a first raw-water inlet end, a second raw-water inlet end, a first four-way solenoid valve, a second four-way solenoid valve, an EDR membrane stack, a freshwater outlet end, and a wastewater outlet end, wherein
each one of the first four-way solenoid valve and the second four-way solenoid valve has a first inlet end, a second inlet end, a first outlet end, and a second outlet end;
the EDR membrane stack has a first inlet port, a second inlet port, a first outlet port, a second outlet port, a first electrode, and a second electrode;
the first raw-water inlet end communicates with the first inlet end of the first four-way solenoid valve, and the second raw-water inlet end communicates with the second inlet end of the first four-way solenoid valve;
the first inlet end of the first four-way solenoid valve is configured to communicate with one of the first outlet end and the second outlet end of the first four-way solenoid valve, and the second inlet end of the first four-way solenoid valve is configured to communicate with the other one of the first outlet end and the second outlet end of the first four-way solenoid valve, so two water routes passing through the first four-way solenoid valve are switchable;
the first inlet end of the second four-way solenoid valve is configured to communicate with one of the first outlet end and the second outlet end of the second four-way solenoid valve, and the second inlet end of the second four-way solenoid valve is configured to communicate with the other one of the first outlet end and the second outlet end of the second four-way solenoid valve, so two water routes passing through the second four-way solenoid valve are switchable;
the first outlet end of the first four-way solenoid valve communicates with the first inlet port of the EDR membrane stack, and the second outlet end of the first four-way solenoid valve communicates with the second inlet port of the EDR membrane stack;
the first outlet port of the EDR membrane stack communicates with the first inlet end of the second four-way solenoid valve, and the second outlet port of the EDR membrane stack communicates with the second inlet end of the second four-way solenoid valve; and
the freshwater outlet end communicates with the first outlet end of the second four-way solenoid valve, and the wastewater outlet end communicates with the second outlet of the second four-way solenoid valve.

2. The switching system of the EDR water purifier as claimed in claim 1, wherein the switching system comprises an electronic control device configured to control exchanging of polarity of the first electrode and the second electrode of the EDR membrane stack, and to control switching of the water routes passing through the first four-way solenoid valve and the second four-way solenoid valve.
